(19) United States
(12) Patent Application Publication
(10) Pub. No.: US 2023/0038000 A1
(43) Pub. Date: Feb. 9, 2023

(54) ACTION IDENTIFICATION METHOD AND APPARATUS, AND ELECTRONIC DEVICE

(71) Applicant: MEGVII (BEIJING) TECHNOLOGY CO., LTD., Haidian District, Beijing (CN)

(72) Inventor: Qian WU, Haidian District, Beijing (CN)

(21) Appl. No.: 17/788,563

(22) PCT Filed: Sep. 30, 2020
(86) PCT No.: PCT/CN2020/119482

§ 371 Date: Jun. 23, 2022

(30) Foreign Application Priority Data
Apr. 23, 2020 (CN) 202010330214.0

(51) Int. Cl. G06V 20/52; G06V 20/40; G06V 40/20; G06T 7/246

(52) U.S. Cl. CPC G06V 20/52; G06V 20/44; G06V 40/20; G06T 7/246; G06V 2201/07; G06T 2207/10016

(57) ABSTRACT

The present application provides an action recognition method and apparatus and an electronic device. The method includes: if a target object is detected from a video frame, acquiring a plurality of images containing the target object, and optical-flow images of the plurality of images; extracting an object trajectory feature of the target object from the plurality of images, and extracting an optical-flow trajectory feature of the target object from the optical-flow images of the plurality of images; and according to the object trajectory feature and the optical-flow trajectory feature, recognizing a type of an action of the target object. Because it combines the time-feature information and the spatial-feature information of the target object, effectively increases the accuracy of the detection and recognition on the action type, and may take into consideration the detection efficiency at the same time, thereby improving the overall detection performance.

### CROSS REFERENCE TO RELEVANT APPLICATIONS

The present application claims the priority of the Chinese patent application filed on Apr. 23, 2020 before the Chinese Patent Office with the application number of 202010330214.0 and the title of “ACTION IDENTIFICATION METHOD AND APPARATUS, AND ELECTRONIC DEVICE”, which is incorporated herein in its entirety by reference.

### TECHNICAL FIELD

The present application relates to the technical field of image processing, and particularly relates to an action recognition method and an apparatus and an electronic device.

### BACKGROUND

The task of video-action detection is to find out, from a video, a segment in which an action might exist, and classify the behaviors that the actions belong to. With the popularization of shooting devices all over the world, there are higher and higher requirements on real-time on-line video-action detection. Currently, mainstream on-line video-action detecting methods usually use a three-dimensional convolutional network, which has a high calculation amount, thereby resulting in a high detection delay. Moreover, a video-action detecting method using a two-dimensional convolutional network has a higher calculating speed, but has a lower accuracy.

In conclusion, the current on-line video-action detecting methods cannot balance the detection accuracy and the detection efficiency at the same time, which results in a poor overall performance.

### SUMMARY

In the first aspect, the present application provides an action recognition method, wherein the method includes:

if a target object is detected from a video frame, acquiring a plurality of images containing the target object, and optical-flow images of the plurality of images;

extracting an object trajectory feature of the target object from the plurality of images, and extracting an optical-flow trajectory feature of the target object from the optical-flow images of the plurality of images; and

according to the object trajectory feature and the optical-flow trajectory feature, recognizing a type of an action of the target object.

In an alternative implementation, the step of, according to the object trajectory feature and the optical-flow trajectory feature, recognizing the type of the action of the target object includes:

according to the object trajectory feature and the optical-flow trajectory feature, determining, from the plurality of images, a target image where the action happens; and

according to the target image and an optical-flow image of the target image, recognizing the type of the action of the target object.

In an alternative implementation, the step of, according to the object trajectory feature and the optical-flow trajectory feature, determining, from the plurality of images, the target image where the action happens includes:

performing the following operations to each of the plurality of images: splicing the object trajectory feature and the optical-flow trajectory feature of the target object in the image, to obtain a composite trajectory feature of the target object; or, summing the object trajectory feature and the optical-flow trajectory feature of the target object in the image, to obtain a composite trajectory feature of the target object; and

according to the composite trajectory feature of the target object, determining, from the plurality of images, the target image where the action happens.

In an alternative implementation, the step of, according to the composite trajectory feature of the target object, determining, from the plurality of images, the target image where the action happens includes:

ordering the plurality of images in a time sequence;

dividing the plurality of images that are ordered into a plurality of first image sets according to preset quantities of images included in each of the first image sets;

for each of the first image sets, sampling the composite trajectory feature of the target object in the first image set by using a preset sampling length, to obtain a sampled feature of the first image set;

inputting the sampled feature of the first image set into a neural network that is trained in advance, and outputting a probability that the first image set includes an image where the action happens, a first deviation amount of a first image in the first image set relative to a starting of an image interval where the action happens, and a second deviation amount of a last image in the first image set relative to an end of the image interval; and

according to the probability that the first image set includes an image where the action happens, the first deviation amount and the second deviation amount, determining the target image where the action happens in the first image set.

In an alternative implementation, the step of, according to the probability that the first image set includes the image where the action happens, the first deviation amount and the second deviation amount, determining the target image where the action happens in the first image set includes:

acquiring a target image set whose probability of including an image where the action happens is not less than a preset value;

according to the first image in the target image set and the first deviation amount, and a second deviation amount of a last image in the target image set relative to an end of the image interval, estimating a plurality of frames of images to be selected that correspond to the starting of the image interval where the action happens, and a plurality of frames of images to be selected that correspond to the end of the image interval;

for the estimated plurality of frames of images to be selected that correspond to the starting of the image interval where the action happens, according to the composite trajectory features of the target objects in the frames of images to be selected, determining first probabilities that each of the frames of images to be selected is used as an action starting image; and according to the first probabilities of each of the images to be selected, determining an actual action starting image from the plurality of frames of images to be selected;

for the estimated plurality of frames of images to be selected that correspond to the end of the image interval where the action happens, according to the composite trajectory features of the target objects in the frames of images to be selected, determining second probabilities that each of the frames of images to be selected is used as an action ending image; and according to the second probabilities of each of the images to be selected, determining an actual action ending image from the plurality of frames of images to be selected; and

determining an image in the target image set located between the actual action starting image and the actual action ending image to be the target image.

In an alternative implementation, the step of, according to the probability that the first image set includes the image where the action happens, the first deviation amount and the second deviation amount, determining the target image where the action happens in the first image set includes:

acquiring a target image set whose probability of including an image where the action happens is not less than a preset value;

determining an image that the first deviation amount directs to in the target image set to be an action starting image, and determining an image that the second deviation amount directs to in the target image set to be an action ending image; and

determining an image in the target image set located between the action starting image and the action ending image to be the target image.

In an alternative implementation, the step of, according to the composite trajectory feature of the target object, determining, from the plurality of images, the target image where the action happens includes:

for each of the plurality of images, according to the composite trajectory feature of the target object in the image, determining a first probability of the image being used as an action starting image, a second probability of the image being used as an action ending image and a third probability of an action happening in the image; and

according to the first probability, the second probability and the third probability of each of the images, determining, from the plurality of images, the target image where the action happens.

In an alternative implementation, the step of, according to the composite trajectory feature of the target object in the image, determining the first probability of the image being used as the action starting image, the second probability of the image being used as the action ending image and the third probability of the action happening in the image includes:

inputting the composite trajectory feature of the target object in the image into a neural network that is trained in advance, and outputting the first probability of the image being used as the action starting image, the second probability of the image being used as the action ending image and the third probability of an action happening in the image.

In an alternative implementation, the step of, according to the first probability, the second probability and the third probability of each of the images, determining, from the plurality of images, the target image where the action happens includes:

according to the first probability, the second probability and a probability requirement that is predetermined, determining, from the plurality of images, an action starting image and an action ending image that satisfy the probability requirement;

according to the action starting image and the action ending image, determining a second image set where the action happens;

sampling the composite trajectory feature of the target object in the second image set by using a preset sampling length, to obtain a sampled feature of the second image set;

inputting the sampled feature of the second image set and the third probability of each of images in the second image set into a neural network that is trained in advance, and outputting a probability that the second image set includes an image where the action happens; and

according to the probability that the second image set includes an image where the action happens, determining the target image where the action happens.

In an alternative implementation, the step of, according to the action starting image and the action ending image, determining the second image set where the action happens includes:

determining a corresponding image interval with any one action starting image as a starting point and with any one action ending image as an ending point to be the second image set where the action happens.

In an alternative implementation, the probability requirement includes:

if the first probability of the image is greater than a preset first probability threshold, and greater than first probabilities of two images preceding and subsequent to the image, determining the image to be the action starting image; and

if the second probability of the image is greater than a preset second probability threshold, and greater than second probabilities of the two images preceding and subsequent to the image, determining the image to be the action ending image.

In an alternative implementation, the step of, according to the probability that the second image set includes the image where the action happens, determining the target image where the action happens includes:

if the probability that the second image set includes an image where the action happens is greater than a preset third probability threshold, determining all of the images in the second image set to be target images where the action happens.

In an alternative implementation, the step of, according to the target image and the optical-flow image of the target image, recognizing the type of the action of the target object includes:

inputting the object trajectory feature of the target object in the target image and the optical-flow trajectory feature of the target object in the optical-flow image of the target image into a predetermined action recognition network, and outputting the type of the action of the target object in the target image.

In an alternative implementation, the step of extracting the object trajectory feature of the target object from the plurality of images, and extracting the optical-flow trajectory feature of the target object from the optical-flow images of the plurality of images includes:

inputting the plurality of images into a predetermined first convolutional neural network, and outputting the object trajectory feature of the target object; and

inputting the optical-flow images of the plurality of images into a predetermined second convolutional neural network, and outputting the optical-flow trajectory feature of the target object.

In the second aspect, the present application further provides an action recognition apparatus, wherein the apparatus includes:

an image acquiring module configured for, if a target object is detected from a video frame, acquiring a plurality of images containing the target object, and optical-flow images of the plurality of images;

a feature extracting module configured for extracting an object trajectory feature of the target object from the plurality of images, and extracting an optical-flow trajectory feature of the target object from the optical-flow images of the plurality of images; and

an action recognition module configured for, according to the object trajectory feature and the optical-flow trajectory feature, recognizing a type of an action of the target object.

In the third aspect, the present application further provides an electronic device, wherein the electronic device includes a processor and a memory, the memory stores a computer-executable instruction that is executable by the processor, and the processor executes the computer-executable instruction to implement the action recognition method stated above.

In the fourth aspect, the present application further provides a computer-readable storage medium, wherein the computer-readable storage medium stores a computer-executable instruction, and when the computer-executable instruction is invoked and executed by a processor, the computer-executable instruction causes the processor to implement the action recognition method stated above.

The action recognition method and apparatus and the electronic device according to the present application include, if a target object is detected from a video frame, acquiring a plurality of images containing the target object, and optical-flow images of the plurality of images; extracting an object trajectory feature of the target object from the plurality of images, and extracting an optical-flow trajectory feature of the target object from the optical-flow images of the plurality of images; and according to the object trajectory feature and the optical-flow trajectory feature, recognizing a type of an action of the target object. In such a mode, by combining the trajectory information of the target object in the video-frame image and the optical-flow information of the target object in the optical-flow images of the images, the type of the action of the target object is identified. Because it combines the time-feature information and the spatial-feature information of the target object, as compared with conventional video-action detecting modes by using a two-dimensional convolutional network, the present application effectively increases the accuracy of the detection and recognition on the action type, and may take into consideration the detection efficiency at the same time, thereby improving the overall detection performance.

The other characteristics and advantages of the present disclosure will be described in the subsequent description. Alternatively, some of the characteristics and advantages may be inferred or unambiguously determined from the description, or may be known by implementing the above-described technical solutions of the present disclosure.

In order to make the above purposes, features and advantages of the present disclosure more apparent and understandable, the present disclosure will be described in detail below with reference to the preferable embodiments and the drawings.

### BRIEF DESCRIPTION OF THE DRAWINGS

In order to more clearly illustrate the technical solutions of the feasible embodiments of the present application or the prior art, the figures that are required to describe the feasible embodiments or the prior art will be briefly introduced below. Apparently, the figures that are described below are embodiments of the present application, and a person skilled in the art may obtain other figures according to these figures without paying creative work.

FIG. 1 is a schematic flow chart of the action recognition method according to an embodiment of the present application;

FIG. 2 is a schematic flow chart of the action recognition method according to another embodiment of the present application;

FIG. 3 is a schematic flow chart of the determination of the target image where the action happens in the action recognition method according to an embodiment of the present application;

FIG. 4 is a schematic flow chart of the determination of the target image where the action happens in the action recognition method according to another embodiment of the present application;

FIG. 5 is a schematic structural diagram of the action recognition apparatus according to an embodiment of the present application; and

FIG. 6 is a schematic structural diagram of the electronic device according to an embodiment of the present application.

Reference numbers: 51—image acquiring module; 52—feature extracting module; 53—action recognition module; 61—processor; 62—memory; 63—bus; and 64—communication interface.

### DETAILED DESCRIPTION

In order to make the objects, the technical solutions and the advantages of the embodiments of the present application clearer, the technical solutions of the present application will be clearly and completely described below with reference to the drawings. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

In view of the problem of conventional on-line video-action detecting methods that they may not balance the detection accuracy and the detection efficiency at the same time, the embodiments of the present application provide an action recognition method and apparatus and an electronic device. The technique may be applied to various scenes where it is required to identify the action type of a target object, and may balance the detection accuracy and the detection efficiency of on-line video-action detection at the same time, thereby improving the overall detection performance. In order to facilitate the comprehension on the present embodiment, firstly the action recognition method according to an embodiment of the present application will be described in detail.

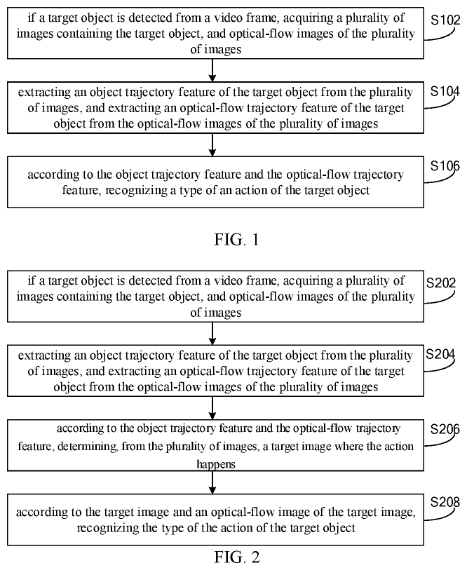

Referring to FIG. 1, FIG. 1 shows a schematic flow chart of the action recognition method according to an embodiment of the present application. It can be seen from FIG. 1 that the method includes the following steps:

Step S102: if a target object is detected from a video frame, acquiring a plurality of images containing the target object, and optical-flow images of the plurality of images.

Here, the target object may be a person, an animal or another movable object, for example a robot, a virtual person and an aircraft. Furthermore, the video frame is the basic unit forming a video. In an embodiment, this step may include acquiring a video frame from a predetermined video, detecting whether the video frame contains the target object, and if yes, then acquiring a video-frame image containing the target object.

In addition, the image containing the target object may be a video-frame image, and may also be a screenshot containing the target object that is captured from a video-frame image. For example, when multiple persons exist in a video-frame image, and the target object is merely one of the persons, an image containing the target object may be captured from the video-frame image containing the multiple persons. Moreover, if the target object is several of the persons, the images corresponding to each of the target objects may be individually captured. For example, this step may include performing trajectory distinguishing to all of the target objects in the video by using a tracking algorithm, to obtain the trajectories of each of the target objects, and subsequently capturing images containing each single target object.

In the present embodiment, this step includes acquiring a plurality of images containing the target object, and optical-flow images of the plurality of images. Here, the optical flow refers to the apparent motion in an image brightness mode. While an object is moving, the brightness modes of the corresponding points in an image are also moving, thereby forming an optical flow. The optical flow expresses the variation of the image, and because it contains the information of the movement of the target, it may be used by an observer to determine the movement state of the target. In some alternative implementations, the optical-flow images corresponding to the plurality of acquired images may be obtained by optical-flow calculation.

Step S104: extracting an object trajectory feature of the target object from the plurality of images, and extracting an optical-flow trajectory feature of the target object from the optical-flow images of the plurality of images.

In some alternative implementations, this step may include inputting the plurality of images into a predetermined first convolutional neural network, and outputting the object trajectory feature of the target object; and inputting the optical-flow images of the plurality of images into a predetermined second convolutional neural network, and outputting the optical-flow trajectory feature of the target object.

Here, the first convolutional neural network and the second convolutional neural network are obtained in advance by training, wherein the first convolutional neural network is configured for extracting an object trajectory feature of the target object from the images, and the second convolutional neural network is configured for extracting the optical-flow trajectory feature of the target object in the optical-flow images.

Step S106: according to the object trajectory feature and the optical-flow trajectory feature, recognizing a type of an action of the target object.

The object trajectory feature reflects the spatial-feature information of the target object, and the optical-flow trajectory feature reflects the time-feature information of the target object. Accordingly, the present embodiment uses the object trajectory feature and the optical-flow trajectory feature of the target object together to identify the action type of the target object. As compared with conventional video-action detecting modes by using a two-dimensional convolutional network, because, based on the spatial-feature information of the target object, its time-feature information is also used, the accuracy of the detection and recognition on the action type of the action of the target object may be increased.

For example, in a plant workshop, in order to prevent a fire disaster, it is required to identify whether a workshop worker is performing a rule-breaking operation. Here, the action recognition method according to the present embodiment may process a real-time video acquired by a monitoring camera, and, based on the video frames in the video, by using the operations of the steps S102 to S106, automatically identify the action that an employee is performing, and may, when it is identified out that a worker is performing the action of a rule-breaking operation, perform alarming, to stop the action of the rule-breaking operation timely. In another possible scene, besides the action detection on the on-line real-time video, an existing video may be played back and detected, whereby it may be identified whether the target object has a history of a specified action.

The action recognition method according to the embodiments of the present application includes, if a target object is detected from a video frame, acquiring a plurality of images containing the target object, and optical-flow images of the plurality of images; extracting an object trajectory feature of the target object from the plurality of images, and extracting an optical-flow trajectory feature of the target object from the optical-flow images of the plurality of images; and according to the object trajectory feature and the optical-flow trajectory feature, recognizing a type of an action of the target object. In such a mode, by combining the trajectory information of the target object in the video-frame image and the optical-flow information of the target object in the optical-flow images of the images, the type of the action of the target object is identified. The recognition mode combines the time-feature information and the spatial-feature information of the target object. As compared with conventional video-action detecting modes by using a two-dimensional convolutional network, the present application effectively increases the accuracy of the detection and recognition on the action type, and may take into consideration the detection efficiency at the same time, thereby improving the overall detection performance.

Based on the action recognition method shown in FIG. 1, the present embodiment further provides another action recognition method, wherein the method emphatically describes an alternative implementation of the step S106 of the above-described embodiment (according to the object trajectory feature and the optical-flow trajectory feature, recognizing the type of the action of the target object). Referring to FIG. 2, FIG. 2 shows a schematic flow chart of the action recognition method. It may be seen from FIG. 2 that the method includes the following steps:

Step S202: if a target object is detected from a video frame, acquiring a plurality of images containing the target object, and optical-flow images of the plurality of images.

Step S204: extracting an object trajectory feature of the target object from the plurality of images, and extracting an optical-flow trajectory feature of the target object from the optical-flow images of the plurality of images.

Here, the step S202 and the step S204 according to the present embodiment correspond to the step S102 the step S104 according to the above embodiment, and the description on their corresponding contents may refer to the corresponding parts of the above embodiment, and is not discussed herein further.

Step S206: according to the object trajectory feature and the optical-flow trajectory feature, determining, from the plurality of images, a target image where the action happens.

In some alternative implementations, the step of determining, from the plurality of images, the target image where the action happens may be implemented by using the following steps 21-22:

performing the following operations to each of the plurality of images: splicing the object trajectory feature and the optical-flow trajectory feature of the target object in the image, to obtain a composite trajectory feature of the target object; or, summing the object trajectory feature and the optical-flow trajectory feature of the target object in the image, to obtain a composite trajectory feature of the target object.

For example, assuming that the object trajectory feature of the target object in an image A is

$$\{ \begin{matrix}1 , 0 , 1 \\ 0 , 1 , 1\end{matrix} \} ,$$

and the optical-flow trajectory feature of the target object in the optical-flow image of the image A is

$$\{ \begin{matrix}0 , 0 , 1 \\ 0 , 1 , 0\end{matrix} \} , t$$

then, in an embodiment, the object trajectory feature and the optical-flow trajectory feature may be spliced, to obtain the composite trajectory feature of the target object, which is

$$\{ \begin{matrix}1 , 0 , 1 \\ 0 , 1 , 1 \\ 0 , 0 , 1 \\ 0 , 1 , 0\end{matrix} \} .$$

In some alternative implementations, the object trajectory feature and the optical-flow trajectory feature may also be summed, to obtain the composite trajectory feature of the target object, which is

$$\{ \begin{matrix}1 , 0 , 2 \\ 0 , 2 , 1\end{matrix} \} .$$

This step includes, according to the composite trajectory feature of the target object, determining, from the plurality of images, the target image where the action happens.

In the following description, two modes are described for, according to the composite trajectory feature of the target object, determining, from the plurality of images, the target image where the action happens.

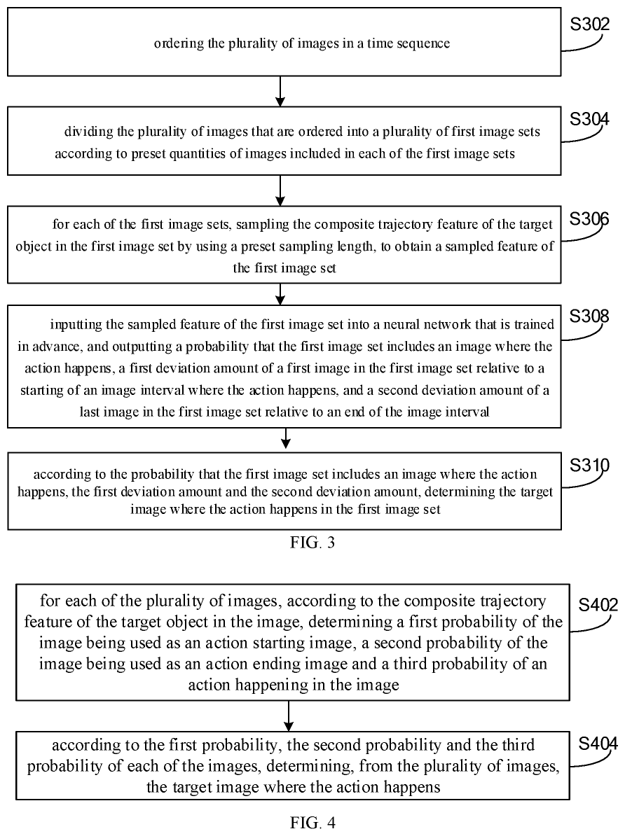

Firstly, referring to FIG. 3, FIG. 3 shows a schematic flow chart of the determination of the target image where the action happens in an action recognition method. The embodiment shown in FIG. 3 includes the following steps:

Step S302: ordering the plurality of images in a time sequence.

Because the plurality of images are obtained according to the video-frame images in the video, the plurality of images may be ordered according to the photographing times of the video-frame image. In the present embodiment, the ordering is performed according to the time sequence.

Step S: dividing the plurality of images that are ordered into a plurality of first image sets according to preset quantities of images included in each of the first image sets.

Here, assuming that the plurality of images are 20 images, and presetting that the image quantity of each of the first image sets is 5, then the images that are ordered may be divided as that the first 1-5 images counted in the ascending order are one first image set, and the 6th to the 10th images, the 11th to the 15th images and the 16th to the 20th images individually form the corresponding first image sets.

In the same manner, assuming that the image quantity of the predetermined first image sets is 6 or 7 or another quantity, the above mode may also be used to divide the plurality of images into a plurality of corresponding first image sets. In some alternative implementations, different image quantities may be set, and the plurality of images may be divided according to the different image quantities of the first image sets, to obtain a plurality of first image sets containing the different image quantities.

Step S306: for each of the first image sets, sampling the composite trajectory feature of the target object in the first image set by using a preset sampling length, to obtain a sampled feature of the first image set.

After the sampling, the lengths of all of the obtained sampled features of each of the first image sets are maintained equal.

Step S308: inputting the sampled feature of the first image set into a neural network that is trained in advance, and outputting a probability that the first image set includes an image where the action happens, a first deviation amount of a first image in the first image set relative to a starting of an image interval where the action happens, and a second deviation amount of a last image in the first image set relative to an end of the image interval.

Step S310: according to the probability that the first image set includes an image where the action happens, the first deviation amount and the second deviation amount, determining the target image where the action happens in the first image set.

Here, assuming that the probability that the first image set includes an image where the action happens is less than a preset probability threshold, then it is considered that the first image set does not contain an image where the action happens, or else, it is considered that the first image set contains an image where the action happens. At this point, according to the first deviation amount of the first image in the first image set relative to the starting of the image interval where the action happens, and the second deviation amount of the last image in the first image set relative to the end of the image interval, the image corresponding to the starting of the image interval where the action happens and the image corresponding to the end of the image interval are determined respectively, thereby determining the image interval where the action happens, wherein each of the images within the image interval is the target image where the action happens. In other words, this step includes acquiring a target image set whose probability of including an image where the action happens is not less than a preset value; determining an image that the first deviation amount directs to in the target image set to be an action starting image, and determining an image that the second deviation amount directs to in the target image set to be an action ending image; and determining an image in the target image set located between the action starting image and the action ending image to be the target image.

For example, assuming that a certain first image set has 10 images, and the probability that the first image set includes an image where the action happens that is obtained after the step S308 is 80%, which is greater than a preset probability threshold 50%, then it is determined that the first image set contains an image where the action happens. Furthermore, it is obtained that the first deviation amount of the first image (i.e., the 1st image) in the first image set relative to the starting of the image interval where the action happens is 3, which indicates that the first image and the image corresponding to the starting of the image interval are spaced by 3 images, and that the second deviation amount of the last image (i.e., the 10th image) relative to the end of the image interval where the action happens is 2, which indicates that the last image and the image corresponding to the end of the image interval are spaced by 2 images. Accordingly, it may be determined that the 4th to the 8th images in the first image set are the image interval where the action happens, and each of the images in that image interval is determined to be a target image where the action happens.

Accordingly, in the step S308 to the step S310, after it is determined that the first image set contains an image where the action happens, it is required to determine, in the first image set, the particular image interval where the action happens. By using the first image in the first image set and the first deviation amount of the first image from the starting of the image interval where the action happens, the image corresponding to the starting of the image interval is reversely deduced. Furthermore, by using the last image in the first image set and the second deviation amount of the last image from the end of the image interval where the action happens, the image corresponding to the end of the image interval is reversely deduced. Therefore, the image interval where the action happens is determined, and in turn the target images where the action happens are determined.

Secondly, referring to FIG. 4, FIG. 4 shows a schematic flow chart of the determination of the target image where the action happens in another action recognition method. The embodiment shown in FIG. 4 includes the following steps:

Step S402: for each of the plurality of images, according to the composite trajectory feature of the target object in the image, determining a first probability of the image being used as an action starting image, a second probability of the image being used as an action ending image and a third probability of an action happening in the image.

In some alternative implementations, this step may include inputting the composite trajectory feature of the target object in the image into a neural network that is trained in advance, and outputting the first probability of the image being used as the action starting image, the second probability of the image being used as the action ending image and the third probability of an action happening in the image. In other words, by means of neural network learning, a completely trained neural network is obtained by in-advance training, so as to, according to the completely trained neural network, according to the composite trajectory feature of the target object in each of the images, calculate the first probability of the image being used as the action starting image, the second probability of the image being used as the action ending image and the third probability of an action happening in the image.

Step S404: according to the first probability, the second probability and the third probability of each of the images, determining, from the plurality of images, the target image where the action happens.

In some alternative implementations, the step of determining, from the plurality of images, the target image where the action happens may be implemented by using the following steps 31-35:

according to the first probability, the second probability and a probability requirement that is predetermined, determining, from the plurality of images, an action starting image and an action ending image that satisfy the probability requirement.

In the present embodiment, the probability requirement includes: if the first probability of the image is greater than a preset first probability threshold, and greater than first probabilities of two images preceding and subsequent to the image, determining the image to be the action starting image; and if the second probability of the image is greater than a preset second probability threshold, and greater than second probabilities of the two images preceding and subsequent to the image, determining the image to be the action ending image.

For example, assuming that the plurality of images are 8 images, which correspond to an image A to an image H, and both of the preset first probability threshold and second probability threshold are 50%, then the first probabilities and the second probabilities of the image A to the image H that are obtained by calculation are shown in the following Table 1:

TABLE 1
First probabilities and second probabilities of image A to image H

| | image | image | image | image | image | image | image | image |
|---|---|---|---|---|---|---|---|---|
| | A | B | C | D | E | F | G | H |
| first | 45% | 60% | 30% | 40% | 55% | 60% | 30% | 20% |
| probability | | | | | | | | |
| second | 40% | 20% | 55% | 50% | 35% | 30% | 70% | 60% |
| probability | | | | | | | | |

It can be known from Table 1 that the images whose first probability is greater than the preset first probability threshold includes the image B, the image E and the image F, but the images whose first probability satisfies the requirement on the local maximum value are merely the image B and the image F. Therefore, the image B and the image F are determined to be the action starting images that satisfy the probability requirement.

In the same manner, as shown in Table 1, the images whose second probability is greater than the preset second probability threshold include the image C, the image D, the image G and the image H, but the images whose second probability is greater than the second probabilities of the two images preceding and subsequent to it are merely the image C and the image G; in other words, the images whose second probability is a local maximum value are merely the image C and the image G. Therefore, the image C and the image G are determined to be the action ending images that satisfy the probability requirement.

This step further includes, according to the action starting image and the action ending image, determining a second image set where the action happens.

Here, the corresponding image intervals with any one determined action starting image as the starting point and with any one determined action ending image as the ending point may be determined to be the second image set where the action happens.

For example, in the example shown in Table 1, the determined action starting images include the image B and the image F, and the determined action ending images include the image C and the image G. Therefore, according to the above-described principle of determining the second image set, the following several second image sets where the action happens may be obtained:

the second image set J1: the image B, and the image C;

the second image set J2: the image F, and the image G; and

the second image set J3: the image B, the image C, the image D, the image E, the image F, and the image G.

(33) sampling the composite trajectory feature of the target object in the second image set by using a preset sampling length, to obtain a sampled feature of the second image set.

Here, the lengths of all of the sampled features of each of the first image sets that are obtained by the sampling are maintained equal.

(34) according to the sampled feature of the second image set and the third probability of each of images in the second image set, determining a probability that the second image set includes an image where the action happens. For example, the sampled feature of the composite trajectory feature of the target object of each of the second image sets and the third probability that an action happens of each of the images in the second image set are inputted into the neural network that is trained in advance, to obtain the probability that the second image set includes an image where the action happens.

(35) according to the probability that the second image set includes an image where the action happens, determining the target image where the action happens.

In the present embodiment, this step includes, if the probability that the second image set includes an image where the action happens is greater than a preset third probability threshold, determining all of the images in the second image set to be target images where the action happens.

For example, assuming that the preset third probability threshold is 45%, and the probabilities of including an image where the action happens corresponding to the second image set J1, the second image set J2 and the second image set J3 are 35%, 50% and 20% respectively, then all of the images in the second image set J2 are determined to be the target images where the action happens, i.e., determining the image F and the image G to be the target images where the action happens.

Accordingly, by using the mode shown in FIG. 3 or FIG. 4, the step of, according to the composite trajectory feature of the target object, determining, from the plurality of images, the target image where the action happens may be realized. Both of the action starting image and the action ending image are the images where the action happens. In an actual operation, the process includes calculating the first probability of the image being used as the action starting image, the second probability of the image being used as the action ending image and the third probability of an action happening in the image of each of the images; subsequently, based on the first probabilities and the second probabilities, determining the action starting images and the action ending images respectively, subsequently according to the action starting images and the action ending images determining several second image sets where the action happens (i.e., the image intervals), and sampling based on the second image sets; and, by referring to the third probabilities corresponding to the images in the second image sets, solving the probabilities of including an image where the action happens of the second image sets, subsequently screening out the second image set that satisfies the probability requirement, and determining the target images where the action happens.

The modes shown in FIG. 3 and FIG. 4 have their individual advantages. For example, the mode shown in FIG. 3 has a higher processing efficiency, and the processing in FIG. 4 has a higher accuracy. In order to combine the advantages of them, in some embodiments, based on the mode shown in FIG. 3, the step S310 may be improved, to obtain another mode of determining the target image, i.e.:

Firstly, the mode includes acquiring, from the obtained first image set, a target image set whose probability of including an image where the action happens is not less than a preset value.

In some embodiments, the preset value may be the preset probability threshold described in the solution shown in FIG. 3. For example, a certain first image set has 10 images, and the probability that the image set includes an image where the action happens that is obtained after the step S308 is 80%, which is greater than a preset probability threshold 50%. Therefore, it is determined that the first image set contains an image where the action happens, and therefore it is determined to be the target image set.

Secondly, the mode includes, according to the first image in the target image set and the first deviation amount, and a second deviation amount of a last image in the target image set relative to an end of the image interval, estimating a plurality of frames of images to be selected that correspond to the starting of the image interval where the action happens, and a plurality of frames of images to be selected that correspond to the end of the image interval.

In some embodiments, the image that the first deviation amount directs to in the target image set, and the neighboring images of the image that is directed to, are determined to be the plurality of frames of images to be selected that correspond to the starting of the image interval where the action happens. In the same manner, the image that the second deviation amount directs to in the target image set, and the neighboring images of the image that is directed to, are determined to be the plurality of frames of images to be selected that correspond to the end of the image interval where the action happens.

Following the above example, it is obtained that the first deviation amount of the first image (i.e., the 1st image) in the target image set relative to the starting of the image interval where the action happens is 3, which indicates that the image that the first deviation amount directs to in the target image set is the 4th frame of the images in the target image set. Therefore, the 3rd frame, the 4th frame and the 5th frame of the images in the target image set are determined to be the plurality of frames of images to be selected that correspond to the starting of the image interval where the action happens. Moreover, the second deviation amount of the last image (i.e., the 10th image) relative to the end of the image interval where the action happens is 2, which indicates that the image that the second deviation amount directs to in the target image set is the 8th frame of the images in the target image set. Therefore, the 7th frame, the 8th frame and the 9th frame of the images in the target image set are determined to be the plurality of frames of images to be selected that correspond to the end of the image interval where the action happens.

Thirdly, the mode includes, for the estimated plurality of frames of images to be selected that correspond to the starting of the image interval where the action happens, according to the composite trajectory features of the target objects in the frames of images to be selected, determining first probabilities that each of the frames of images to be selected is used as an action starting image; and according to the first probabilities of each of the images to be selected, determining an actual action starting image from the plurality of frames of images to be selected.

In some embodiments, the image to be selected that corresponds to the highest first probability may be determined to be the actual action starting image.

Subsequently, the mode includes, for the estimated plurality of frames of images to be selected that correspond to the end of the image interval where the action happens, according to the composite trajectory features of the target objects in the frames of images to be selected, determining second probabilities that each of the frames of images to be selected is used as an action ending image; and according to the second probabilities of each of the images to be selected, determining an actual action ending image from the plurality of frames of images to be selected.

In some embodiments, the image to be selected that corresponds to the highest second probability may be determined to be the actual action starting image.

Finally, the mode includes determining an image in the target image set located between the actual action starting image and the actual action ending image to be the target image.

Following the above example, the determined actual action starting image is the 3rd frame of the images in the target image set, and the actual action ending image is the 8th frame of the images in the target image set. Accordingly, the 3rd to the 8th images in the target image set may be determined to be the target images where the action happens.

Step S208: according to the target image and an optical-flow image of the target image, recognizing the type of the action of the target object.

Here, in some alternative implementations, this step may include inputting the object trajectory feature of the target object in the target image and the optical-flow trajectory feature of the target object in the optical-flow image of the target image into a predetermined action recognition network, and outputting the type of the action of the target object in the target image.

In the action recognition method according to the present embodiment, by combining the time-feature information and the spatial-feature information of the target object, the action of the target object is identified, which effectively increases the accuracy of the detection and recognition on the action type, and may take into consideration the detection efficiency at the same time, thereby improving the overall detection performance.

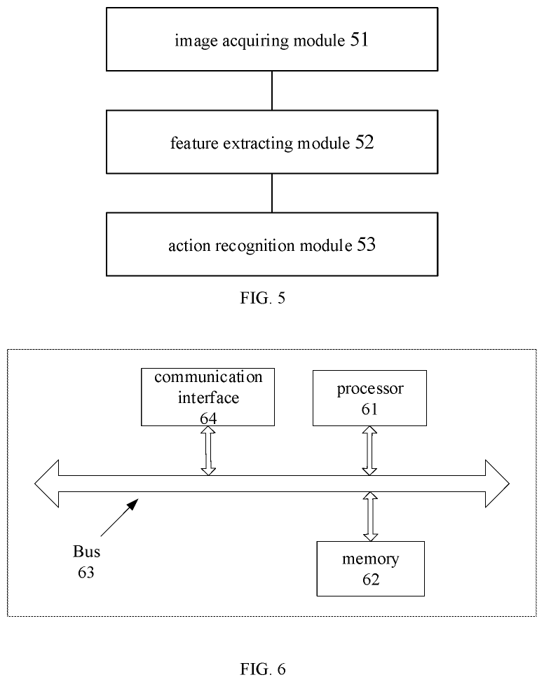

As corresponding to the action recognition method shown in FIG. 1, an embodiment of the present application further provides an action recognition apparatus. Referring to FIG. 5, FIG. 5 shows a schematic structural diagram of an action recognition apparatus. As shown in FIG. 5, the apparatus includes an image acquiring module 51, a feature extracting module 52 and an action recognition module 53 that are sequentially connected, wherein the functions of the modules are as follows:

the image acquiring module 51 is configured for, if a target object is detected from a video frame, acquiring a plurality of images containing the target object, and optical-flow images of the plurality of images;

the feature extracting module 52 is configured for extracting an object trajectory feature of the target object from the plurality of images, and extracting an optical-flow trajectory feature of the target object from the optical-flow images of the plurality of images; and

the action recognition module 53 is configured for, according to the object trajectory feature and the optical-flow trajectory feature, recognizing a type of an action of the target object.

The action recognition apparatus according to the embodiment of the present application is configured for, if a target object is detected from a video frame, acquiring a plurality of images containing the target object, and optical-flow images of the plurality of images; extracting an object trajectory feature of the target object from the plurality of images, and extracting an optical-flow trajectory feature of the target object from the optical-flow images of the plurality of images; and according to the object trajectory feature and the optical-flow trajectory feature, recognizing a type of an action of the target object. In the apparatus, by combining the trajectory information of the target object in the video-frame image and the optical-flow information of the target object in the optical-flow images of the images, the type of the action of the target object is identified. Because it combines the time-feature information and the spatial-feature information of the target object, as compared with conventional video-action detecting modes by using a two-dimensional convolutional network, the present application effectively increases the accuracy of the detection and recognition on the action type, and may take into consideration the detection efficiency at the same time, thereby improving the overall detection performance.

In some alternative implementations, the action recognition module 53 is further configured for: according to the object trajectory feature and the optical-flow trajectory feature, determining, from the plurality of images, a target image where the action happens; and according to the target image and an optical-flow image of the target image, recognizing the type of the action of the target object.

In some alternative implementations, the action recognition module 53 is further configured for: performing the following operations to each of the plurality of images: splicing the object trajectory feature and the optical-flow trajectory feature of the target object in the image, to obtain a composite trajectory feature of the target object; or, summing the object trajectory feature and the optical-flow trajectory feature of the target object in the image, to obtain a composite trajectory feature of the target object; and according to the composite trajectory feature of the target object, determining, from the plurality of images, the target image where the action happens.

In some alternative implementations, the action recognition module 53 is further configured for: ordering the plurality of images in a time sequence; dividing the plurality of images that are ordered into a plurality of first image sets according to preset quantities of images included in each of the first image sets; for each of the first image sets, sampling the composite trajectory feature of the target object in the first image set by using a preset sampling length, to obtain a sampled feature of the first image set; inputting the sampled feature of the first image set into a neural network that is trained in advance, and outputting a probability that the first image set includes an image where the action happens, a first deviation amount of a first image in the first image set relative to a starting of an image interval where the action happens, and a second deviation amount of a last image in the first image set relative to an end of the image interval; and according to the probability that the first image set includes an image where the action happens, the first deviation amount and the second deviation amount, determining the target image where the action happens in the first image set.

In some alternative implementations, the action recognition module 53 is further configured for: for each of the plurality of images, according to the composite trajectory feature of the target object in the image, determining a first probability of the image being used as an action starting image, a second probability of the image being used as an action ending image and a third probability of an action happening in the image; and according to the first probability, the second probability and the third probability of each of the images, determining, from the plurality of images, the target image where the action happens.

In some alternative implementations, the action recognition module 53 is further configured for: inputting the composite trajectory feature of the target object in the image into a neural network that is trained in advance, and outputting the first probability of the image being used as the action starting image, the second probability of the image being used as the action ending image and the third probability of an action happening in the image.

In some alternative implementations, the action recognition module 53 is further configured for: according to the first probability, the second probability and a probability requirement that is predetermined, determining, from the plurality of images, an action starting image and an action ending image that satisfy the probability requirement; according to the action starting image and the action ending image, determining a second image set where the action happens; sampling the composite trajectory feature of the target object in the second image set by using a preset sampling length, to obtain a sampled feature of the second image set; inputting the sampled feature of the second image set and the third probability of each of images in the second image set into a neural network that is trained in advance, and outputting a probability that the second image set includes an image where the action happens; and according to the probability that the second image set includes an image where the action happens, determining the target image where the action happens.

In some alternative implementations, the action recognition module 53 is further configured for: determining a corresponding image interval with any one action starting image as a starting point and with any one action ending image as an ending point to be the second image set where the action happens.

In an embodiment of the present application, the probability requirement includes: if the first probability of the image is greater than a preset first probability threshold, and greater than first probabilities of two images preceding and subsequent to the image, determining the image to be the action starting image; and if the second probability of the image is greater than a preset second probability threshold, and greater than second probabilities of the two images preceding and subsequent to the image, determining the image to be the action ending image.

In some alternative implementations, the action recognition module 53 is further configured for: if the probability that the second image set includes an image where the action happens is greater than a preset third probability threshold, determining all of the images in the second image set to be target images where the action happens.

In some alternative implementations, the action recognition module 53 is further configured for: inputting the object trajectory feature of the target object in the target image and the optical-flow trajectory feature of the target object in the optical-flow image of the target image into a predetermined action recognition network, and outputting the type of the action of the target object in the target image.

In some alternative implementations, the feature extracting module 52 is further configured for: inputting the plurality of images into a predetermined first convolutional neural network, and outputting the object trajectory feature of the target object; and inputting the optical-flow images of the plurality of images into a predetermined second convolutional neural network, and outputting the optical-flow trajectory feature of the target object.

The principle of the implementation and the obtained technical effects of the action recognition apparatus according to the embodiments of the present application are the same as those of the embodiments of the action recognition method stated above. In order to simplify the description, the contents that are not mentioned in the embodiments of the action recognition apparatus may refer to the corresponding contents in the embodiments of the action recognition method stated above.

An embodiment of the present application further provides an electronic device. As shown in FIG. 6, FIG. 6 is a schematic structural diagram of the electronic device. The electronic device includes a processor 61 and a memory 62, the memory 62 stores a machine-executable instruction that is executable by the processor 61, and the processor 61 executes the machine-executable instruction to implement the action recognition method stated above.

In the embodiment shown in FIG. 6, the electronic device further includes a bus 63 and a communication interface 64, wherein the processor 61, the communication interface 64 and the memory 62 are connected via the bus.

The memory 62 may include a high-speed random access memory (RAM), and may further include a non-volatile memory, for example, at least one magnetic-disk storage. The communicative connection between the system network element and at least one other network element is realized by using at least one communication interface 64 (which may be wired or wireless), which may use Internet, a Wide Area Network, a Local Area Network, a Metropolitan Area Network and so on. The bus may be an ISA bus, a PCI bus, an EISA bus and so on. The bus may include an address bus, a data bus, a control bus and so on. In order to facilitate the illustration, it is represented merely by one bidirectional arrow in FIG. 6, but that does not mean that there is merely one bus or one type of bus.

The processor 61 may be an integrated-circuit chip, and has the capacity of signal processing. In implementations, the steps of the above-described method may be completed by using an integrated logic circuit of the hardware or an instruction in the form of software of the processor 61. The processor 61 may be a generic processor, including a Central Processing Unit (referred to for short as CPU), a Network Processor (referred to for short as NP) and so on. The processor may also be a Digital Signal Processing (referred to for short as DSP), an Application Specific Integrated Circuit (referred to for short as ASIC), a Field-Programmable Gate Array (referred to for short as FPGA), or another programmable logic device, discrete gate or transistor logic device, or discrete hardware component, and may implement or execute the methods, the steps and the logic block diagrams according to the embodiments of the present application. The generic processor may be a microprocessor, and the processor may also be any conventional processor. The steps of the method according to the embodiments of the present application may be directly embodied as executed by a hardware decoding processor, or executed by a combination between hardware in the decoding processor and a software module. The software module may exist in a storage medium well known in the art, such as a random access memory, a flash memory, a read-only memory, a programmable read-only memory or an electrically erasable programmable memory, and a register. The storage medium exists in the memory, and the processor 61 reads the information in the memory 62, and cooperates with its hardware to implement the steps of the action recognition method according to the above-described embodiments.

An embodiment of the present application further provides a machine-readable storage medium, wherein the machine-readable storage medium stores a machine-executable instruction, and when the machine-executable instruction is invoked and executed by a processor, the machine-executable instruction causes the processor to implement the action recognition method stated above. The optional implementations may refer to the above-described process embodiments, and are not discussed herein further.

The computer program product for the action recognition method, the action recognition apparatus and the electronic device according to the embodiments of the present application includes a computer-readable storage medium storing a program code, and an instruction contained in the program code may be configured to implement the action recognition method according to the above-described process embodiments. The optional implementations may refer to the process embodiments, and are not discussed herein further.

The functions, if implemented in the form of software function units and sold or used as an independent product, may be stored in a nonvolatile computer-readable storage medium that is executable by a processor. On the basis of such a comprehension, the substance of the technical solutions according to the present application, or the part thereof that makes a contribution over the prior art, or part of the technical solutions, may be embodied in the form of a software product. The computer software product is stored in a storage medium, and contains multiple instructions configured so that a computer device (which may be a personal computer, a server, a network device and so on) implements all or some of the steps of the methods according to the embodiments of the present application. Moreover, the above-described storage medium includes various media that may store a program code, such as a USB flash disk, a mobile hard disk drive, a read-only memory (ROM), a random access memory (RAM), a diskette and an optical disc.

In addition, in the description on the embodiments of the present application, unless explicitly defined or limited otherwise, the terms “mount”, “connect” and “link” should be interpreted broadly. For example, it may be fixed connection, detachable connection, or integral connection; it may be mechanical connection or electrical connection; and it may be direct connection or indirect connection by an intermediate medium, and may be the internal communication between two elements. For a person skilled in the art, the particular meanings of the above terms in the present application may be comprehended according to particular situations.

In the description of the present application, it should be noted that the terms that indicate orientation or position relations, such as “center”, “upper”, “lower”, “left”, “right”, “vertical”, “horizontal”, “inside” and “outside”, are based on the orientation or position relations shown in the drawings, and are merely for conveniently describing the present application and simplifying the description, rather than indicating or implying that the device or element must have the specific orientation and be constructed and operated according to the specific orientation. Therefore, they should not be construed as a limitation on the present application. Moreover, the terms “first”, “second” and “third” are merely for the purpose of describing, and should not be construed as indicating or implying the degrees of importance.

Finally, it should be noted that the above-described embodiments are merely alternative embodiments of the present application, and are intended to explain the technical solutions of the present application, and not to limit them, and the protection scope of the present application is not limited thereto. Although the present application is explained in detail with reference to the above embodiments, a person skilled in the art should understand that a person skilled in the art may, within the technical scope disclosed by the present application, easily envisage modifications or variations on the technical solutions set forth in the above embodiments, or make equivalent substitutions to some of the technical features thereof, and those modifications, variations or substitutions do not make the essence of the corresponding technical solutions depart from the spirit and scope of the technical solutions of the embodiments of the present application, and should all be encompassed by the protection scope of the present application. Therefore, the protection scope of the present application should be subject to the protection scope of the appended claims.

### INDUSTRIAL APPLICABILITY

In the action recognition method and apparatus and the electronic device according to the present application, by combining the trajectory information of the target object in the video-frame image and the optical-flow information of the target object in the optical-flow images of the images, the type of the action of the target object is identified, which, because it combines the time-feature information and the spatial-feature information of the target object, effectively increases the accuracy of the detection and recognition on the action type, and may take into consideration the detection efficiency at the same time, thereby improving the overall detection performance.

1. An action recognition method, wherein the method comprises:
when a target object is detected from a video frame, acquiring a plurality of images containing the target object, and optical-flow images of the plurality of images;
extracting an object trajectory feature of the target object from the plurality of images, and extracting an optical-flow trajectory feature of the target object from the optical-flow images of the plurality of images; and
according to the object trajectory feature and the optical-flow trajectory feature, recognizing a type of an action of the target object.

2. The action recognition method according to claim 1, wherein the step of, according to the object trajectory feature and the optical-flow trajectory feature, recognizing the type of the action of the target object comprises:
according to the object trajectory feature and the optical-flow trajectory feature, determining, from the plurality of images, a target image where the action happens; and
according to the target image and an optical-flow image of the target image, recognizing the type of the action of the target object.

3. The action recognition method according to claim 2, wherein the step of, according to the object trajectory feature and the optical-flow trajectory feature, determining, from the plurality of images, the target image where the action happens comprises:
performing the following operations to each of the plurality of images: splicing the object trajectory feature and the optical-flow trajectory feature of the target object in the image, to obtain a composite trajectory feature of the target object; or, summing the object trajectory feature and the optical-flow trajectory feature of the target object in the image, to obtain a composite trajectory feature of the target object; and
according to the composite trajectory feature of the target object, determining, from the plurality of images, the target image where the action happens.

4. The action recognition method according to claim 3, wherein the step of, according to the composite trajectory feature of the target object, determining, from the plurality of images, the target image where the action happens comprises:
ordering the plurality of images in a time sequence;
dividing the plurality of images that are ordered into a plurality of first image sets according to preset quantities of images comprised in each of the first image sets;
for each of the first image sets, sampling the composite trajectory feature of the target object in the first image set by using a preset sampling length, to obtain a sampled feature of the first image set;
inputting the sampled feature of the first image set into a neural network that is trained in advance, and outputting a probability that the first image set comprises an image where the action happens, a first deviation amount of a first image in the first image set relative to a starting of an image interval where the action happens, and a second deviation amount of a last image in the first image set relative to an end of the image interval; and
according to the probability that the first image set comprises an image where the action happens, the first deviation amount and the second deviation amount, determining the target image where the action happens in the first image set.

5. The action recognition method according to claim 4, wherein the step of, according to the probability that the first image set comprises the image where the action happens, the first deviation amount and the second deviation amount, determining the target image where the action happens in the first image set comprises:
acquiring, from the first image set, a target image set whose probability of comprising an image where the action happens is not less than a preset value;
according to the first image in the target image set and the first deviation amount, and a second deviation amount of a last image in the target image set relative to an end of the image interval, estimating a plurality of frames of images to be selected that correspond to the starting of the image interval where the action happens, and a plurality of frames of images to be selected that correspond to the end of the image interval;
for the estimated plurality of frames of images to be selected that correspond to the starting of the image interval where the action happens, according to the composite trajectory features of the target objects in the frames of images to be selected, determining first probabilities that each of the frames of images to be selected is used as an action starting image; and according to the first probabilities of each of the images to be selected, determining an actual action starting image from the plurality of frames of images to be selected;
for the estimated plurality of frames of images to be selected that correspond to the end of the image interval where the action happens, according to the composite trajectory features of the target objects in the frames of images to be selected, determining second probabilities that each of the frames of images to be selected is used as an action ending image; and according to the second probabilities of each of the images to be selected, determining an actual action ending image from the plurality of frames of images to be selected; and
determining an image in the target image set located between the actual action starting image and the actual action ending image to be the target image.

6. The action recognition method according to claim 4, wherein the step of, according to the probability that the first image set comprises the image where the action happens, the first deviation amount and the second deviation amount, determining the target image where the action happens in the first image set comprises:
acquiring a target image set whose probability of comprising an image where the action happens is not less than a preset value;
determining an image that the first deviation amount directs to in the target image set to be an action starting image, and determining an image that the second deviation amount directs to in the target image set to be an action ending image; and
determining an image in the target image set located between the action starting image and the action ending image to be the target image.

7. The action recognition method according to claim 3, wherein the step of, according to the composite trajectory feature of the target object, determining, from the plurality of images, the target image where the action happens comprises:
for each of the plurality of images, according to the composite trajectory feature of the target object in the image, determining a first probability of the image being used as an action starting image, a second probability of the image being used as an action ending image and a third probability of an action happening in the image; and
according to the first probability, the second probability and the third probability of each of the images, determining, from the plurality of images, the target image where the action happens.

8. The action recognition method according to claim 7, wherein the step of, according to the composite trajectory feature of the target object in the image, determining the first probability of the image being used as the action starting image, the second probability of the image being used as the action ending image and the third probability of the action happening in the image comprises:
inputting the composite trajectory feature of the target object in the image into a neural network that is trained in advance, and outputting the first probability of the image being used as the action starting image, the second probability of the image being used as the action ending image and the third probability of an action happening in the image.

9. The action recognition method according to claim 7, wherein the step of, according to the first probability, the second probability and the third probability of each of the images, determining, from the plurality of images, the target image where the action happens comprises:
according to the first probability, the second probability and a probability requirement that is predetermined, determining, from the plurality of images, an action starting image and an action ending image that satisfy the probability requirement;
according to the action starting image and the action ending image, determining a second image set where the action happens;
sampling the composite trajectory feature of the target object in the second image set by using a preset sampling length, to obtain a sampled feature of the second image set;
according to the sampled feature of the second image set and the third probability of each of images in the second image set, determining a probability that the second image set comprises an image where the action happens; and
according to the probability that the second image set comprises an image where the action happens, determining the target image where the action happens.

10. The action recognition method according to claim 9, wherein the step of, according to the action starting image and the action ending image, determining the second image set where the action happens comprises:
determining a corresponding image interval with any one action starting image as a starting point and with any one action ending image as an ending point to be the second image set where the action happens.

11. The action recognition method according to claim 9, wherein the probability requirement comprises:
when the first probability of the image is greater than a preset first probability threshold, and greater than first probabilities of two images preceding and subsequent to the image, determining the image to be the action starting image; and
when the second probability of the image is greater than a preset second probability threshold, and greater than second probabilities of the two images preceding and subsequent to the image, determining the image to be the action ending image.

12. The action recognition method according to claim 9, wherein the step of, according to the probability that the second image set comprises the image where the action happens, determining the target image where the action happens comprises:
when the probability that the second image set comprises an image where the action happens is greater than a preset third probability threshold, determining all of the images in the second image set to be target images where the action happens.

13. The action recognition method according to claim 2, wherein the step of, according to the target image and the optical-flow image of the target image, recognizing the type of the action of the target object comprises:
inputting the object trajectory feature of the target object in the target image and the optical-flow trajectory feature of the target object in the optical-flow image of the target image into a predetermined action recognition network, and outputting the type of the action of the target object in the target image.

14. The action recognition method according to claim 1, wherein the step of extracting the object trajectory feature of the target object from the plurality of images, and extracting the optical-flow trajectory feature of the target object from the optical-flow images of the plurality of images comprises:
inputting the plurality of images into a predetermined first convolutional neural network, and outputting the object trajectory feature of the target object; and
inputting the optical-flow images of the plurality of images into a predetermined second convolutional neural network, and outputting the optical-flow trajectory feature of the target object.

15. (canceled)

16. An electronic device, wherein the electronic device comprises a processor and a memory, the memory stores a computer-executable instruction that is executable by the processor, and the processor executes the computer-executable instruction to implement the action recognition method.

17. A computer-readable storage medium, wherein the computer-readable storage medium stores a computer-executable instruction, and when the computer-executable instruction is invoked and executed by a processor, the computer-executable instruction causes the processor to implement the action recognition method.

18. The action recognition method according to claim 8, wherein the step of, according to the first probability, the second probability and the third probability of each of the images, determining, from the plurality of images, the target image where the action happens comprises:
according to the first probability, the second probability and a probability requirement that is predetermined, determining, from the plurality of images, an action starting image and an action ending image that satisfy the probability requirement;
according to the action starting image and the action ending image, determining a second image set where the action happens;
sampling the composite trajectory feature of the target object in the second image set by using a preset sampling length, to obtain a sampled feature of the second image set;
according to the sampled feature of the second image set and the third probability of each of images in the second image set, determining a probability that the second image set comprises an image where the action happens; and
according to the probability that the second image set comprises an image where the action happens, determining the target image where the action happens.

19. The action recognition method according to claim 10, wherein the probability requirement comprises:
when the first probability of the image is greater than a preset first probability threshold, and greater than first probabilities of two images preceding and subsequent to the image, determining the image to be the action starting image; and
when the second probability of the image is greater than a preset second probability threshold, and greater than second probabilities of the two images preceding and subsequent to the image, determining the image to be the action ending image.

20. The action recognition method according to claim 10, wherein the step of, according to the probability that the second image set comprises the image where the action happens, determining the target image where the action happens comprises:
when the probability that the second image set comprises an image where the action happens is greater than a preset third probability threshold, determining all of the images in the second image set to be target images where the action happens.

21. The action recognition method according to claim 11, wherein the step of, according to the probability that the second image set comprises the image where the action happens, determining the target image where the action happens comprises:
when the probability that the second image set comprises an image where the action happens is greater than a preset third probability threshold, determining all of the images in the second image set to be target images where the action happens.
